(19) United States
(12) Patent Application Publication
(10) Pub. No.: US 2015/0213198 A1
(43) Pub. Date: Jul. 30, 2015

(54) SYSTEM AND METHOD FOR COORDINATING CARE OF A PATIENT ACROSS A CARE CONTINUUM

(71) Applicants: Gene Groys, Moreland Hills, OH (US); Tim Wilson, Stow, OH (US)

(72) Inventors: Gene Groys, Moreland Hills, OH (US); Tim Wilson, Stow, OH (US)

(21) Appl. No.: 14/606,674

(22) Filed: Jan. 27, 2015

Related U.S. Application Data
(60) Provisional application No. 61/931,748, filed on Jan. 27, 2014.

(51) Int. Cl. G06F 19/00; G06Q 50/24

(52) U.S. Cl. CPC G06F 19/322; G06Q 50/24

(57) ABSTRACT

A care coordination system provides collection and coordination of patient information among subscribed users along a patient care continuum. The care coordination system further enables the subscribed users to interact with the patient data and with one another relative to the patient data. In addition, the care coordination system includes notification functionality to alert providers of events to enable collaboration among subscribed users for quicker response and provision of appropriate care for adverse events.

This application claims priority to U.S. Provisional Application Ser. No. 61/931,748, filed Jan. 27, 2014, entitled “SYSTEM AND METHOD FOR COORDINATING CARE OF A PATIENT ACROSS A CARE CONTINUUM”, the entirety of which is incorporated herein by reference.

### BACKGROUND OF THE INVENTION

1. Field of the Invention

This application relates generally to patient care coordination and, more specifically, to a care coordination system to collect, coordinate, and distribute patient information across care providers along a care continuum.

2. Description of Related Art

In healthcare, a care continuum relates to the care of a patient across levels and providers. For example, for a patient, the care continuum can include acute care received at a hospital for a condition and post-acute care received at a skilled nursing facility and/or home care provided by a home care nurse. Due to aggressive market evolution, it is beneficial for all (i.e., patient, hospital, skilled nursing facility, and home care nurse) to increase coordination and collaboration in the care of the patient. For instance, with reimbursements, conventional fee for service arrangement are declining and are increasingly being replaced with bundling or capitation in which a set amount of funds are available (per patient, per time period, per condition, etc.) for reimbursement to any service providers. Accordingly, hospitals, specialists, primary care provider (PcP), skilled nursing facilities, home care nurses, etc., effectively share this amount set aside for the patient.

In view of this trend, service providers are incentivized to reduce costs while maintaining or improving the level of care provided. To achieve these goals, increase collaboration across the care continuum is desirable. For instance, once discharged following acute care, the hospital would like to ensure the patient remains on track to recovery and/or health maintenance in post-acute care since the hospital can be penalized for re-admittance of a patient for the same condition. Moreover, given the incentive for increased collaboration and penalties for a decline in health even outside a sphere of control, partnership decisions become important. That is, careful control of a list of preferred providers with which to refer a patient following discharge is critical.

### BRIEF SUMMARY OF THE INVENTION

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of the summary is to present some concepts related to some exemplary non-limiting embodiments in a simplified form as a prelude to the more detailed description of the various embodiments that follow.

In various, non-limiting embodiments, a care coordination system provides collection and coordination of patient information among subscribed users, including the patient, provider, payer or other service providers, along a patient care continuum. The care coordination system further enables the subscribed users to interact with the patient data and with one another relative to the patient data. In addition, the care coordination system includes notification functionality to alert subscribed users of events to enable collaboration among subscribed users for quicker response and provision of appropriate care for adverse events.

These and other embodiments are described in more detail below.

### BRIEF DESCRIPTION OF THE DRAWING

Various non-limiting embodiments are further described with reference the accompanying drawings in which:

FIG. 1 illustrates a block diagram of an exemplary, non-limiting care coordination system according to one or more aspects;

FIG. 2 illustrates a patient care continuum and data sources utilized by an exemplary, non-limiting care coordination system;

FIGS. 3-6 illustrates an exemplary, non-limiting embodiment of patient transitions, within the care coordination system, between different levels of care along the care continuum;

FIGS. 7-10 illustrate an exemplary, non-limiting embodiment for intervening and collaboration among subscribed users to transfer a patient in response to adverse events;

FIG. 11 illustrates coordinated care provided along a care continuum as enabled by one or more aspects of a care coordination system described herein;

FIG. 12 is a block diagram representing an exemplary, non-limiting networked environment, including cloud or internet based, in which various embodiments described herein can be implemented; and

FIG. 13 is a block diagram representing an exemplary, non-limiting computing system or operating environment in which one or more aspects of various embodiments described herein can be implemented.

### DETAILED DESCRIPTION OF THE INVENTION

Embodiments of the invention relate to a care coordination system and associated methods for collecting mission-critical patient data from every care-environment or setting from which the patient may receive care and enabling access to that data to everyone involved in the care of that patient. The care coordination system identifies all data elements that are required for a successful transition from one level of care to another. The care coordination system facilitates and tracks collection of the identified data elements, and generates a digitized transition record that is made available, via the care coordination system, to everyone involved in the patient care, including the patient. Such intelligent collection of mission-critical data across different care settings, creates a single, contiguous view of the patient across data silos associated with different venues of care that the patient has utilized.

The care coordination system integrates data from multiple clinical systems associated with each care setting into a comprehensive clinical patient snapshot and intelligently merges additional, relevant patient data gained during and after the transition to a new care setting. Accordingly, the data collection process is ongoing throughout the lifecycle of the patient record. As such, the care coordination system maintains continuity of patient data across the care continuum.

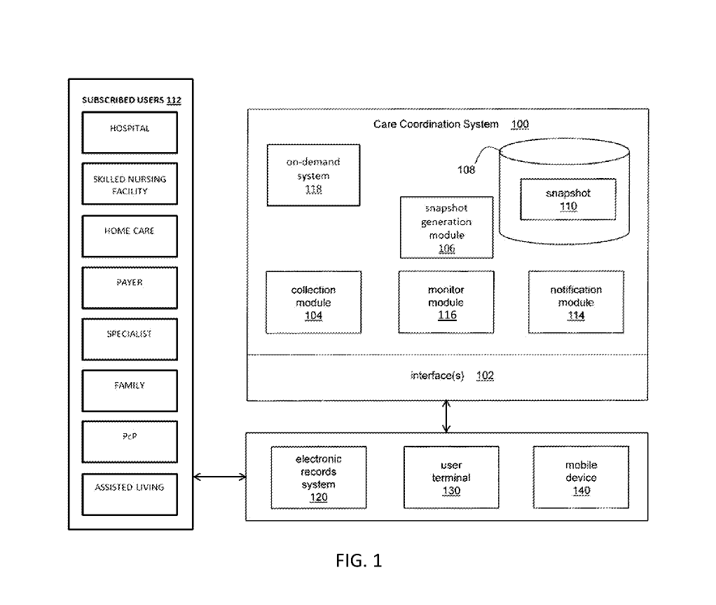

Turning to FIG. 1, illustrated is a block diagram of an exemplary, non-limiting care coordination system in accordance with one or more aspects. As shown in FIG. 1, a care coordination system 100 is illustrated that includes one or more interface(s) 102 employable by the care coordination system 100, and/or external systems, to receive and transmit data corresponding to a patient. According to one example, interface 102 can include a web-based interface such as a web page or web site accessible via a web browser. In another example, the interfaces 102 can incorporate a variety of application program interfaces (APIs) such as RESTful APIs accessible via the hypertext transport protocol (HTTP) with a web browser application executing on a user terminal 130 or with an application executing on a mobile device 140. In addition, the interfaces 102 can include mechanisms to utilize APIs of other systems, such as electronic records system 120, to collect information on a patient from a subscribed user 112 (i.e., hospital, skilled nursing facility, insurance provider, etc.). It is appreciated, information on a patient may be, additionally or alternatively, collected directly from the patient, a patient questionnaire, or a diagnostic unit used by the patient in a home setting.

In one particular embodiment, data transmitted corresponding to a patient can be limited based upon clinical necessity. Clinical necessity is the level or specificity of information identified in a care coordination system 100. Clinical necessity may be established or qualified via a network of trust model. The network of trust model is a mechanism for identifying responsible parties and the information that may be collected and the information each responsible party may access, be privy to, or control, corresponding to their relationship or responsibility to the patient. Care continuum subscribed users 112 entrusted with the patient's care may also be further entrusted with the responsibility of identifying or managing the clinical necessity of the provided data, manually. Subscribed users 112 can manage this information at the time of input or based upon changes in the patient's conditions. Data control can be further controlled and identified based upon upstream and/or downstream subscribed users. Upstream subscribed users are responsible parties with anticipated or future interaction with the patient and downstream subscribed users are responsible parties with previous or continuing interaction with the patient. Clinical necessity can be identified and controlled upstream and/or downstream.

Subscribed users 112 may be identified in a care coordination system. The subscribes users 112 are the responsible parties for a patient and include, but are not limited to, the patient, the family of the patient, the primary care provider (PcP), the hospital, the skilled nursing facility, the home care provider, the payer, the specialist, the assisted living facility, the social worker, or other agencies designated to receive information and/or provide responsibility for a particular patient. Access rights can be distinguished based upon a particular subscribed party, thereby, limiting or isolating the information shared between parties or filter which information is provided to a particular party. In particular embodiments, the information provided in a patient snapshot 110 may be patient focused. In alternative embodiments, the information provided in a patient snapshot 110 may be based upon information that is important to a payer, an insurer, a care facility, a provider and/or a social worker. By example, information may be provided to manage reimbursement controls, referral controls, service provider approvals, in-network provider selectivity, such as Acountable Care Organization (ACO) selectivity, or the like. Moreover, information on multiple patients may be provided to a provider or payer in order to prioritize patient needs across multiple patients under the subscribed party's respective responsibility.

Subscribed users can provide and/or access pertinent patient information through a variety of channels. These channels may include web access through a secure website and/or mobile application. The web access may further incorporate Health Insurance Portability and Accountability Act (HIPAA) compliant, subscription based, event notifications.

The care coordination system 100 can communicate with subscribed users 112 via the Internet, a local area network (LAN), a wide area network (WAN), or a combination thereof over one or more wired or wireless links. For example, a computing device (e.g., electronic records system 120, user terminal 130, or mobile device 140) associated with a subscribed user 112 can connect wirelessly, via WiFi or the like, to a first LAN or WAN. The first LAN or WAN, in turn is connected via a cellular communication link or a wired linked to the Internet. Also, connected to the Internet is a second LAN or WAN to which the care coordination system 100 is connected wired or wirelessly. It is to be appreciated that the above connection scheme is an example of one possible setup and that other network topologies are employable with the aspects described herein and the claimed subject matter. For instance the care coordination system 100 can be implemented as a cloud-based or internet-based system.

Data may be further transferred through a secure data system integration allowing the sharing of information across various electronic records systems 120. Secured data system integration allows multiple upstream and downstream subscribed users 112 to share information while also maintaining independent electronic records systems 120. By integrating multiple electronic records systems 120, the data collection module 104 collects and/or enters information to/from these electronic records systems using a variety of standard and/or custom data protocols and procedures. For example, a single integration scheme may not be suitable for all records system even with known standards (e.g. HL7 or de facto standards from electronic health record (EHR) vendor consolidation) and, thus, integration may require tailoring to some extent.

In an aspect, the care coordination system 100 includes a data collection module 104 configured to obtain patient information from a variety of sources. For instance, patient information can be acquired directly from a subscribed user 112 or from electronic patient records maintained by electronic records system 120 of a subscribed user 112 on a care continuum of the patient. Such information can include full patient records maintained by the subscribed user 112, discharge packets, or the like. Typically, complete information is not required, or can interfere with collaboration of subscribed users 112 along the care continuum. Accordingly, the care coordination system 100 includes a snapshot generation module 106 that generates a patient snapshot 110 based at least in part on the patient information obtained by the data collection module 104. Moreover, this information, and information outside of the patient snapshot 110, may be organized within the care coordination system 100 for retention by a data store 108.

The snapshot 110 can include identification of a condition of the patient requiring care, a list of medications taken by the patient, discharge instructions for ongoing maintenance of the condition and/or for recovery from the condition, and the like. In other words, the snapshot generation module 106 distills patient information into a consumable snapshot that provides essential information to a subscribed user 112 to understand a current condition of the patient and to determine steps required in the treatment of the patient. According to one aspect, a consolidated patient snapshot 110 can be generated through secured data system integration among multiple independent electronic records systems 120 managed by various providers or designated subscribers. Thereby, multiple communication channels may be used to generate a single patent snapshot 110 in a care coordination system 100.

Care coordination system 100 includes a monitor module 116 that updates the snapshot 110 as treatment of the patient progresses and/or as the patient transitions from one level of care to another. For example, updated vital information can be periodically captured and/or uploaded and the snapshot 110 is updated accordingly. Moreover, the monitor module 116 can identify adverse events, such as missed appointments, a decline in patient health, failures to take prescribed actions, etc. In response to adverse events, the care coordination system 100 can issue alerts 124 or notifications 122 to appropriate facilities and/or persons. According to an aspect, messages, including alerts 124 and/or notifications 122 can be provided by a notification module 114. that the notification module 114 may transmit the messages to a variety of persons or facilities associated with the patient according to the snapshot 110 and/or through the one or more electronic record systems. Messages can be transmitted via text message, automated voice calls, emails, push notifications to an application on user terminal 130 or mobile device 140, or system notifications that are provided upon subsequent access to the care coordination system via the interfaces 102. Messages may be, additionally or alternatively, issued based upon a degree of urgency. The manner in which a message is issued may be further managed by the notification module 114. By example, more urgent messages may be sent directly to the subscribed user via text message. Alternatively, less urgent messages may be provided on an event calendar for review at a later time. Read-receipts may be utilized, by example, to confirm messages have been acknowledged within a designated timeline.

The following description provides an exemplary process performed by the care coordination system 100 for a patient within a care continuum that involves at least a hospital, a skilled nursing facility, and a home care provider. The exemplary process involves transitions between the levels of care of the care continuum, and highlight the functions performed by the care coordination system 100 before, during, and following such transitions.

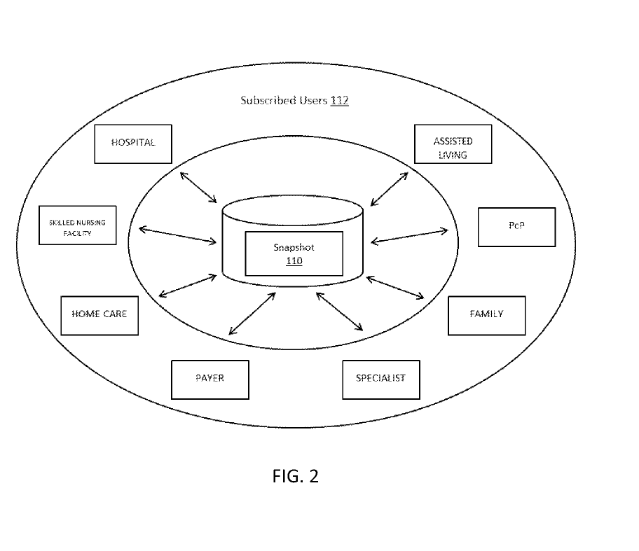

Turning to FIG. 2, illustrated is a patient care continuum, identifying subscribed users 112, and data sources utilized by the care coordination system described herein. To maintain continuity of care, each subscribed user 112 involved in the care of the patient should be able to collaborate over transitional patient data, which constantly evolves as the patient receives care. The care coordination system employs a collaboration model utilizing a combination of communication technologies and application interfaces to connect each individual and/or subscribed user 112 involved in the care of a patient. A data collection module 104, as illustrated in FIG. 1, is configured to obtain patient information from one or more patient record systems 120. The patient record systems 120 may be associated with one or more subscribed users 112 that are responsible for reporting a condition or transfer of a patient.

The subscribed user 112 may further gain access to more detailed information through the care coordination system 100 via an on-demand system 118, as illustrated in FIG. 1. By example, discharge packets may be provided and accessible over the web but not designated to be identified in the patient snapshot 110. This access may be further facilitated to the subscribed user 112 through the care coordination system 100. Through the on-demand system 118, subscribed users may further access information made available in designated electronic records, thereby providing adequate controls to extract the necessary information selected and/or required at a particular juncture in patient care. By example, a subscribed user 112 may be granted access to identify patient history, patient allergies, etc., items that may not be particularly designated or identified in the patient snapshot 110, based upon the selected level of specificity.

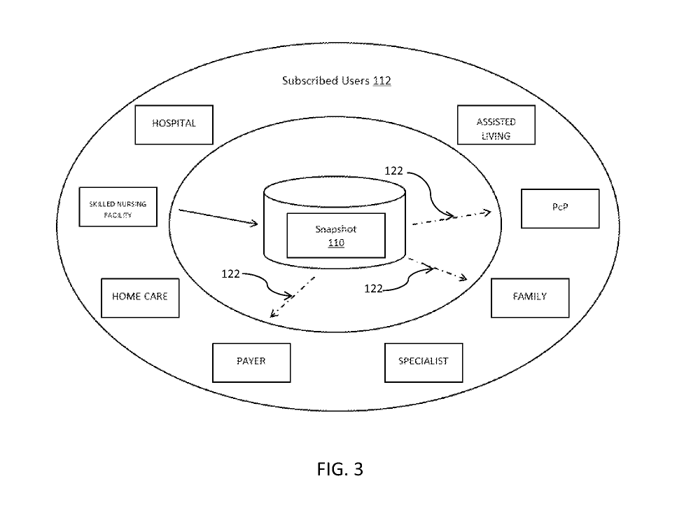

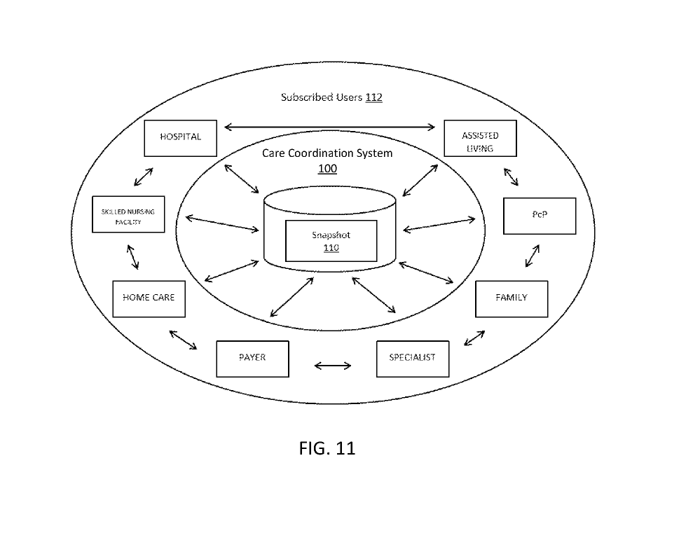

Turning to FIGS. 3-6, the transition of the patient from the hospital to the skilled nursing facility is utilized as an example to highlight one or more aspects of the care coordination system. These figures depict data collections and communications associated with steps of the transition of the patient between environments. The care coordination system collects critical data (see, e.g., FIG. 11) that is required for patient transfer (e.g., data employable to validate a set of conditions required prior to transfer). Through the automated collection and dissemination of patient data provided by the care coordination system, data collection and transfer inefficiencies that generate errors during venue transition are eliminated.

The care coordination system 100 captures the patient snapshot 110 for transfer or admission of a patient to a subscribed user 112 (i.e. skilled nursing facility). By example, in FIG. 3 the care coordination system 100 captures a patient snapshot 110 for a patient at a time of admission to a first subscribed user 112 (i.e. skilled nursing facility, as illustrated in FIG. 3). The patient snapshot 110 may additionally capture patient information regarding a previous dismissal in the instance a transitional event relates to a transition of a patient from one subscribed user 112 to another subscribed user 112. The change in condition or transfer of the patient is captured through the data collection module 104. Using the information in the patient snapshot 110, the notification module 114 communicates with one or more subscribed users 112 by alerting and/or notifying the one or more subscribed users 112 (i.e. payer, family, and primary care provider (PcP)) of the change in condition or transfer. In FIG. 3, the messages are transmitted to one or more subscribed users indicating the patient is admitted.

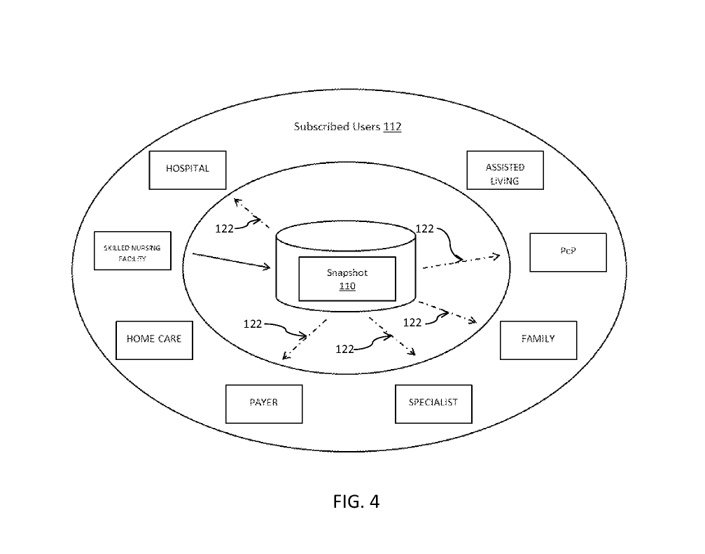

Turning to FIG. 4, the care coordination system 100 captures the progress of the patient and updates the patient snapshot 110. By example, the monitor module, as identified in FIG. 1, may facilitate monitoring the progress of the patient for updating the patient snapshot 110. As illustrated in FIG. 4, the patient progress, as it relates to an impending discharge, is monitored during the treatment of the first subscribed user (i.e. skilled nursing facility, as illustrated in FIG. 4) and the patient snapshot 110 is updated. The care coordination system 100 may communicate the patient progress to one or more subscribed users 112 through the notification module 114, illustrated in FIG. 1. Moreover, the care coordination system 100 may identify when the patient is eligible for transfer to a second subscribed user based, at least in part, on the patient snapshot 110.

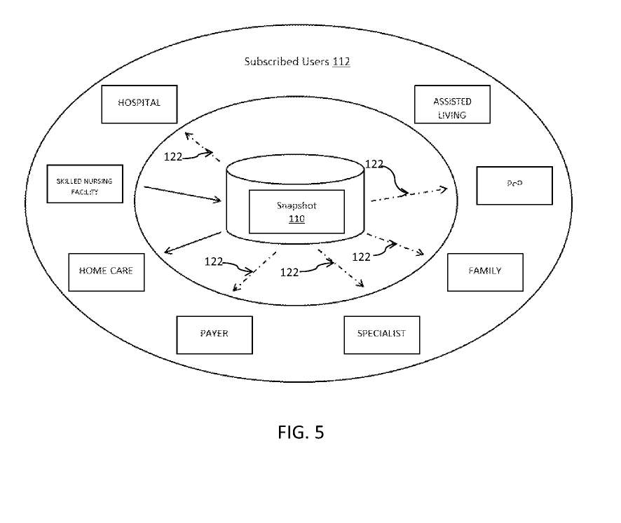

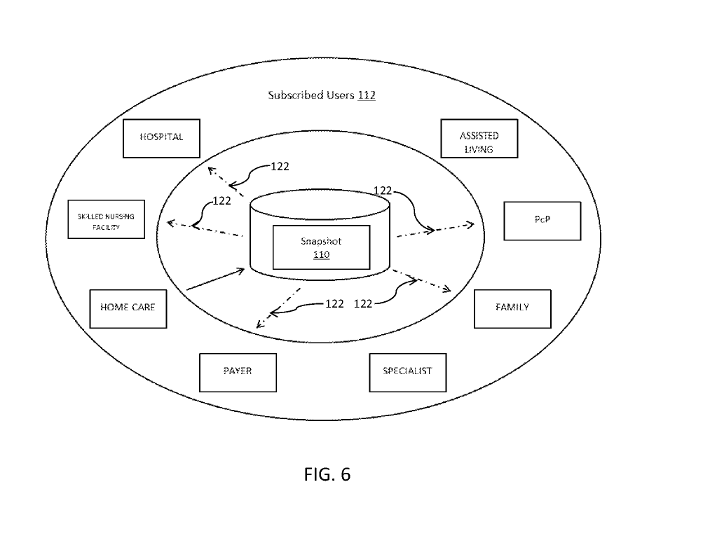

Referring now to FIG. 5, the second subscribed user (i.e. homecare provider, as illustrated in FIG. 5) is selected and notified and a transition process is initiated. One or more subscribed users 112 may be additionally notified (i.e. hospital, payer, family, specialist, assisted living, etc.). As discussed in greater detail below, the care coordination system 100 may assist with the required approvals from the one or more subscribed users 112 before transfer. Upon a successful transfer, the care coordination system 100 confirms the successful transfer or change in progress of the patient. In particular, FIG. 6 illustrates notifying one or more subscribed users 112 of the successful transfer to the second subscribed user.

Upon the successful transfer to the second subscribed user, the progress of the patient may be tracked during the treatment at the second subscribed user. When an improvement or decline in health of the patient is detected at the second subscribed user, one or more subscribed users may be notified or alerted. The notification may request approval for a transfer of the patient to a different subscribed user. Again, upon successful transfer of the patient back to the first subscribed user or a different subscribed user, one or more subscribed users are notified through the care coordination system 100.

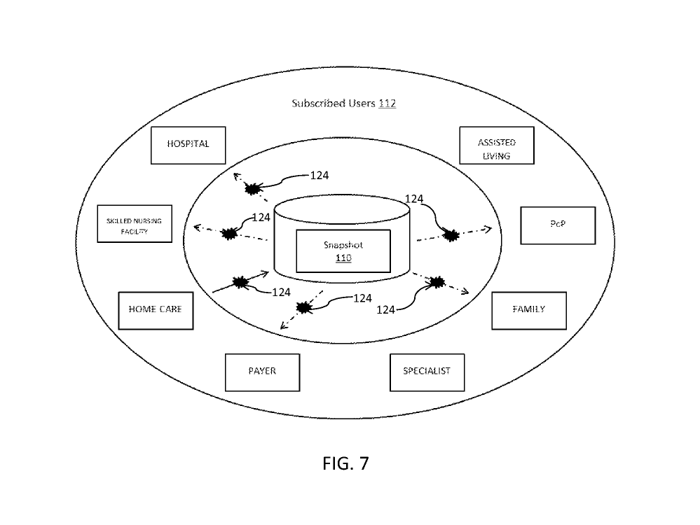

Turning to FIGS. 7-10, an exemplary intervention process is illustrated. As shown in these figures, the care coordination system 100 enables collaboration of involved subscribed users 112 to transfer the patient to an appropriate level of care, based on adverse events. These figures illustrate the features and steps taken by the care coordination system relative to an example in which a skilled nursing facility transfers the patient from a home care environment back into the skilled nursing facility. Such a transfer can quickly and effectively occur because the skilled nursing facility, via the care coordination system, has access to post-transition patient information, and, thus, becomes alerted to the decline. Accordingly, the skilled nursing facility can help to facilitate the transfer of the patient from the home care setting back to the skilled nursing facility, and, therefore, eliminate penalties involved with re-admittance to the hospital. Additionally and/or alternatively, pre-certifications with a payer may be initiated to make sure a particular facility can continue to provide care for that patient under an identified policy.

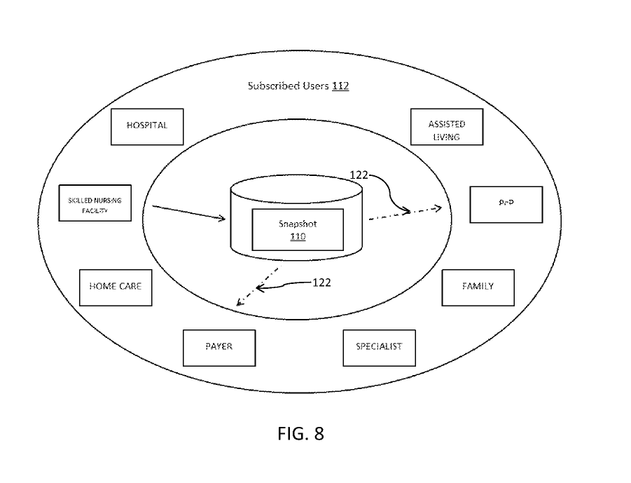

In FIG. 7, a decline in the patient's health is identified, the patient snapshot 110 is updated, and the care coordination system 100 alerts or notifies one or more subscribed users 112. Turning to FIG. 8, in this particular embodiment, once one or more subscribed users 112 receives the message, the first subscribed user (i.e. skilled nursing facility, as illustrated by FIG. 8) recommends a referral through the care coordination system 100 to treat the patient based upon an updated snapshot 110. As illustrated by FIGS. 7-8, the first subscribed user recommends a referral back to their facility. The referral by the first subscribe user may, alternatively, recommend a referral to a different service provider through a plurality of available service providers. A selected available service provider may then be designated as a subscribed user upon acquiring approval. Moreover, through the care coordination system 100, approval may be required before a patient is transferred. As discussed in greater detail above, when more information is required to recommend or approve a referral, additional information may be accessed through the on-demand system 118, illustrated in FIG. 1. The on-demand data may access the one or more electronic records systems 120 through the care coordination system 100 or acquire the information from the data store 108.

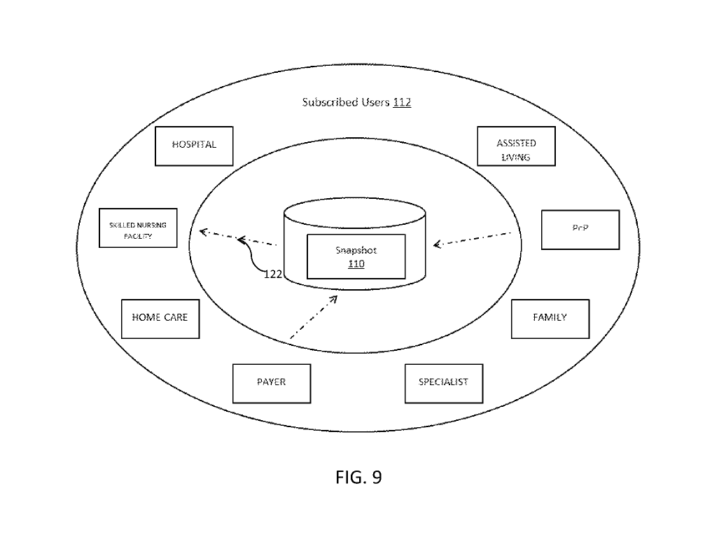

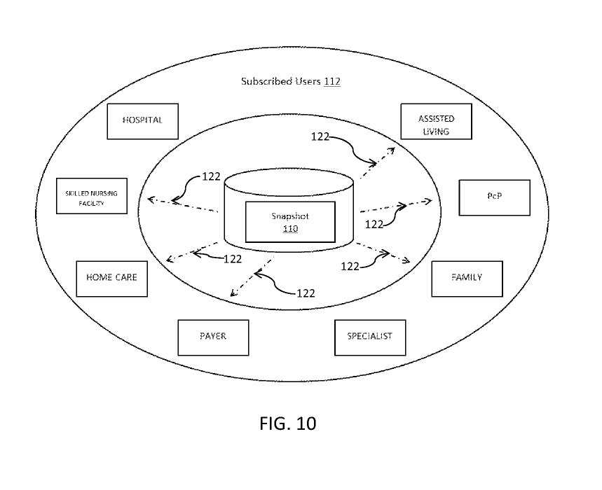

Referring now to FIG. 9, the one or more subscribed users (i.e. primary care provider (PcP) and payer) approve the recommended referral and an updated snapshot 110 of the care coordination system 100 is issued. One or more subscribed users (i.e. skilled nursing facility) are notified through an updated snapshot 110 of the approved referral. The patient may be transferred and/or admitted based upon the approved referral. Upon transfer and/or admittance, the patient snapshot 110 is updated and one or more necessary subscribed users (i.e. home care, payer, family, primary care provider (PcP), skilled nursing facility) are notified, as illustrated by FIG. 10.

The care coordination system 100 may further increase the efficiency of a patient transfer by updating the patient snapshot 110 in advance of the patient transfer. Additionally and alternatively, messages and/or information may be transferred to subscribed users 112 in advance of the patient transfer. This facilitates providing adequate care, triaging a patient, providing accommodations, and/or acquiring plan approvals before the transfer occurs. The patient snapshot 110 may be further updated upon execution of a patient transfer to acknowledge receipt of the patient or the required plan approvals. This further assists to identify the responsible subscribed user during and upon execution of a patient transfer.

The data included in the snapshot 110 may additionally or alternatively be acquired directly from the patient or other subscribed user in the home setting. This allows the care coordination system 100 to provide efficient patient follow-up, particularly in a high-risk condition. Specifically, using the consolidated patient snapshot 110, proprietary statistical algorithms may be used to identify follow-up questions for the patient or other subscribed user in order to update the patient snapshot 110. By updating the patient snapshot in this manner, readmission outcomes may be greatly reduced.

Readmission outcomes may be further reduced by providing a predictive readmission risk score. The predictive readmission risk score may be based on prior readmission outcomes and/or a combination of attributes about a particular patient or patient snapshot 110. Examples of the attributes may include diagnosis, medications, activities of daily living, compliance, weights, vitals, demographic data, living conditions, family support, elapsed time since discharge, and transition history. Patients with a predictive readmission risk score above a pre-determined threshold may be placed on an automated call list or provided custom care parameters. The predictive readmission risk score may change or be adjusted based upon subsequent data, including responses to automated questions, elapsed time, and subscribed user input. Automated questions may be provided based upon question sets or questions trees that produce the highest change in risk based upon patient's condition. The automated questions may be compiled from a combination of changes which may produce the largest risk change. The patient's answers and outcomes may be fed directly back into the care coordination system 100, thereby updating the patient snapshot 110. Alternatively, the patient's answers and outcomes may be sent directly through the care coordination system 100 to a designated subscribed user for review before updating the patient snapshot 110.

According to an aspect and as illustrated by FIG. 11, the care coordination system, via collection, storage, and dissemination of data, enables collaborative care to occur along all levels of the care continuum, wherein collaboration is enabled around the data. Illustrative examples of data sections identified as critical to maintaining continuity of care across the care continuum include patient demographics, patient profile, financials, care team, stay summary, weights, vitals, clinical, therapy, dietary, cognitive labs, medications, orders, face to face interactions, medical necessity, social services, follow-up appointments, resident/responsible party authorizations, staff member authorizations, etc. The collection of this data and the delivery of this data through the care coordination system enable the collaboration over patient care among a variety of persons and facilities. Based upon the collaboration of this data, an adequate history of a patient may be identified and managed by the care coordination system by identifying instances where a patient may be off track, by issuing messages, by identifying discharges or admittances, by managing when a patient may be expected, and/or a collection of other communications or actions.

One of ordinary skill in the art can appreciate that the various embodiments of a care coordination system described herein can be implemented in connection with any computing device, client device, or server device, which can be deployed as part of a computer network or in a distributed computing environment such as the cloud. The various embodiments described herein can be implemented in substantially any computer system or computing environment having any number of memory or storage units, any number of processing units, and any number of applications and processes occurring across any number of storage units and processing units. This includes, but is not limited to, cloud environments with physical computing devices (e.g., servers) aggregating computing resources (i.e., memory, persistent storage, processor cycles, network bandwidth, etc.) which are distributed among a plurality of computable objects. The physical computing devices can intercommunicate via a variety of physical communication links such as wired communication media (e.g., fiber optics, twisted pair wires, coaxial cables, etc.) and/or wireless communication media (e.g., microwave, satellite, cellular, radio or spread spectrum, free-space optical, etc.). The physical computing devices can be aggregated and exposed according to various levels of abstraction for use by application or service providers, to provide computing services or functionality to client computing devices. The client computing devices can access the computing services or functionality via application program interfaces (APIs), web browsers, or other standalone or networked applications. Accordingly, aspects of the care coordination system can be implemented based on such a cloud environment. For example, the care coordination system 100, can reside in the cloud environment such that the computer-executable instruction implementing the functionality thereof are executed with the aggregated computing resources provided by the plurality of physical computing devices. The cloud environment provides one or more methods of access to the care coordination system 100, which are utilized, by example, on a user terminal 130 or on a mobile device 140. These methods of access include IP addresses, domain names, URIs, etc. Since the aggregated computing resources can be provided by physical computing device remotely located from one another, the cloud environment can include additional devices such as a routers, load balancers, switches, etc., that appropriately coordinate network data.

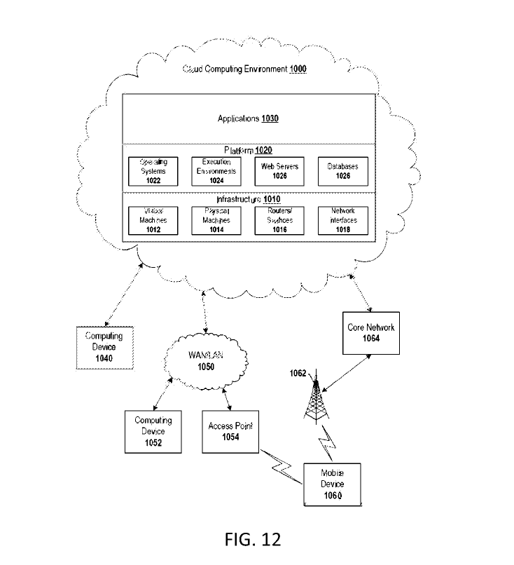

FIG. 12 provides a schematic diagram of an exemplary networked or distributed computing environment, such as a cloud computing environment 1000. The cloud computing environment 1000 represents a collection of computing resources available, typically via the Internet, to one or more client devices. The cloud computing environment 1000 comprises various levels of abstraction: infrastructure 1010, a platform 1020, and applications 1030. Each level, from infrastructure 1010 to applications 1030 is generally implemented on top of lower levels, with infrastructure 1010 representing the lowest level.

Infrastructure 1010 generally encompasses the physical resources and components on which cloud services are deployed. For instance, infrastructure 1010 can include virtual machines 1012, physical machines 1014, routers/switches 1016, and network interfaces 1018. The network interfaces 1018 provide access to the cloud computing environment 1000, via the Internet or other network, from client devices such as computing devices 1040, 1052, 1060, etc. That is, network interfaces 1018 provide an outermost boundary of cloud computing environment 1000 and couple the cloud computing environment 1000 to other networks, the Internet, and client computing devices. Routers/switches 1016 couple the network interfaces 1018 to physical machines 1014, which are computing devices comprising computer processors, memory, mass storage devices, etc. Hardware of physical machines 1014 can be virtualized to provide virtual machines 1012. In an aspect, virtual machines 1012 can be executed on one or more physical machines 1014. That is, one physical machine 1014 can include a plurality of virtual machines 1012.

Implemented on infrastructure 1010, platform 1020 includes software that form a foundation for applications 1030. The software forming platform 1020 includes operating systems 1022, programming or execution environments 1024, web servers 1026, and databases 1028. The software of platform 1020 can be installed on virtual machines 1012 and/or physical machines 1014.

Applications 1030 include user-facing software applications, implemented on platform 1020, that provide services to various client devices. In this regard, the care coordination system 100 described herein is an example application 1030. As illustrated in FIG. 10, client devices can include computing devices 1040, 1052 and mobile device 1060. Computing devices 1040, 1052 can be directly coupled to the Internet, and therefore the cloud computing environment 1000, or indirectly coupled to the Internet via a WAN/LAN 1050. The WAN/LAN 1050 can include an access point 1054 that enables wireless communications (e.g., WiFi) with mobile device 1060. In this regard, via access point 1054 and WAN/LAN 1050, mobile device 1060 can communicate wirelessly with the cloud computing environment 1000. Mobile device 1060 can also wirelessly communicate according to cellular technology such as, but not limited to, GSM, LTE, WiMAX, HSPA, etc. Accordingly, mobile device 1060 can wireless communicate with a base station 1062, which is coupled to a core network 1064 of a wireless communication provider. The core network 1064 includes a gateway to the Internet and, via the Internet, provides a communication path to the cloud computing environment 1000.

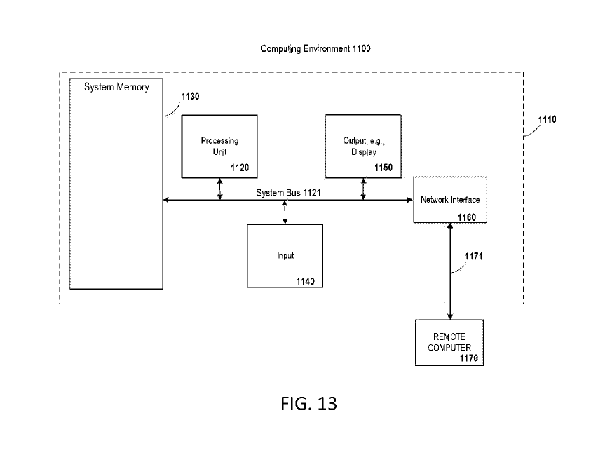

As mentioned, advantageously, the techniques described herein can be applied to any device where it is desirable to integrate a collection module 104 and a monitor module 116 for updating a patient snapshot 110 in the context of a care coordination system 100. It can be understood, therefore, that handheld, portable and other computing devices and computing objects of all kinds are contemplated for use in connection with the various embodiments of a care coordination system. Accordingly, the below general purpose computer described below in FIG. 13 is but one example of a computing device.

Embodiments can partly be implemented via an operating system, for use by a developer of services for a device or object, and/or included within application software that operates to perform one or more functional aspects of the various embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 13 thus illustrates an example of a suitable computing system environment 1100 in which one or more aspects of the embodiments described herein can be implemented, although as made clear above, the computing system environment 1100 is only one example of a suitable computing environment and is not intended to suggest any limitation as to scope of use or functionality. In addition, the computing system environment 1100 is not intended to be interpreted as having any dependency relating to any one or combination of components illustrated in the exemplary computing system environment 1100.

With reference to FIG. 13, an exemplary device for implementing one or more embodiments includes a general purpose computing device in the form of a computer 1110. Components of computer 1110 may include, but are not limited to, a processing unit 1120, a system memory 1130, and a system bus 1122 that couples various system components including the system memory to the processing unit 1120.

Computer 1110 typically includes a variety of computer readable media and can be any available media that can be accessed by computer 1110. The system memory 1130 may include computer storage media in the form of volatile and/or nonvolatile memory such as read only memory (ROM) and/or random access memory (RAM). By way of example, and not limitation, system memory 1130 may also include an operating system, application programs, other program modules, and program data. According to a further example, computer 1110 can also include a variety of other media (not shown), which can include, without limitation, RAM, ROM, EEPROM, flash memory or other memory technology, compact disk (CD) ROM, digital versatile disk (DVD) or other optical disk storage, or other tangible and/or non-transitory media which can be used to store desired information.

A user can enter commands and information into the computer 1110 through input devices 1140. A monitor or other type of display device is also connected to the system bus 1122 via an interface, such as output interface 1150. In addition to a monitor, computers can also include other peripheral output devices such as speakers and a printer, which may be connected through output interface 1150.

The computer 1110 may operate in a networked or distributed environment using logical connections to one or more other remote computers, such as remote computer 1170. The remote computer 1170 may be a personal computer, a server, a router, a network PC, a peer device or other common network node, or any other remote media consumption or transmission device, and may include any or all of the elements described above relative to the computer 1110. The logical connections depicted in FIG. 13 include a network 1172, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to implement a care coordination system as described herein.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As utilized herein, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the term “exemplary” is intended to mean “serving as an illustration or example of something.”

Various functions described herein can be implemented in hardware, software, or any combination thereof. If implemented in software, the functions can be stored on or transmitted over as one or more instructions or code on a computer-readable medium. Computer-readable media includes both computer-readable storage media and communication media including any medium that facilitates transfer of a computer program from one place to another. A computer-readable storage media can be any available media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Also, a connection can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Illustrative embodiments have been described, hereinabove. It will be apparent to those skilled in the art that the above devices and methods may incorporate changes and modifications without departing from the general scope of the claimed subject matter. It is intended to include all such modifications and alterations within the scope of the claimed subject matter. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for care coordination, comprising:
a data collection module configured to obtain patient information of a patient from one or more subscribed users involved with a care of the patient;
a snapshot module configured to generate a patient snapshot based at least in part on the patient information obtained by the data collection module;
a notification module configured to communicate messages to the one or more subscribed users based at least in part on the patient snapshot; and
an interface configured to facilitate access to the patient snapshot by the one or more subscribed users.

2. The system of claim 1, further comprising:
a monitor module configured to analyze the patient snapshot to identify events,
wherein the messages communicated by the notification module to the one or more subscribed users are responsive to the events identified.

3. The system of claim 2, wherein the events include transitional events related to transitions of the patient along a care continuum.

4. The system of claim 2, wherein the events include changes to the patient snapshot.

5. The system of claim 1, wherein the data collection module is further configured to periodically capture the patient information.

6. The system of claim 5, wherein the snapshot module updates the patient snapshot based on each periodic capture of the patient information.

7. The system of claim 1, wherein the one or more subscribers are linked via a care continuum that establishes a network of trust model corresponding to the care of the patient for a condition.

8. The system of claim 7, wherein the data collection module, the snapshot module, the notification module, and the interface utilize the network of trust model to control at least one of access to the patient snapshot, collection of patient information, or communications of message related to the patient snapshot.

9. The system of claim 1, wherein the interface module is further configured to integrate with one or more electronic record systems respectively associated with the one or more subscribed users to push at least a portion of the patient snapshot to the one or more electronic record systems.

10. The system of claim 1, wherein the notification module is further configured to integrate with one or more electronic record systems respectively associated with the one or more subscribed users to push the messages to the one or more electronic record systems.

11. The system of claim 1, wherein the notification module is configured to identify a mode of communication for the messages based upon a degree of urgency.

12. The system of claim 1, further comprising:
an on-demand system configured to access supplementary patient information available in one or more patient record systems respectively associated with the one or more subscribed users,
wherein the supplementary patient information supplements information included in the patient snapshot.

13. The system of claim 1, wherein the data collection module utilizes a predictive readmission risk score for the patient to control collection of information from the one or more subscribed users.

14. A method for coordinating care a patient in a collaborative care environment, comprising:
updating a patient snapshot for the patient at a time when care of the patient transitions to a first subscribed user;
transmitting notifications to one or more subscribed users indicating transition of the patient;
monitoring the patient during the care of the patient by the first subscribed user and updating the patient snapshot based on the monitoring; and
notifying one or more subscribed users of updates to the patient snapshot during the care of the patient by the first subscribed user.

15. The method of claim 14, further comprising:
updating the patient snapshot responsive to transition of care of the patient to a second subscribed user; and
notifying the one or more subscribed users of the transition of care to the second subscribed user.

16. The method of claim 15, further comprising:
selecting the second subscribed user from one or more available providers.

17. The method of claim 16, further comprising acquiring one or more plan approvals, wherein the second subscribed user is selected based on one or more plan approvals.

18. The method of claim 15, further comprising:
monitoring the patient during the care of the patient by the second subscribed user;
alerting the one or more subscribed users when an adverse event is detected;
requesting approval for transitioning the care of the patient to a different subscribed user; and
notifying the one or more subscribed users upon the transition of care to the different subscribed user.

19. The method of claim 18, wherein the different subscribed user is the first subscribed user such the transition of care is a transition from the second subscribed user back to the first subscribed user.

20. A computer-readable storage medium having stored thereon computer-executable instructions for a care coordination system, the computer-executable instructions, when executed, configure a processor to:
collect patient information relating to a condition of a patient from one or more subscribed users of the care coordination system, the one or more subscribed users being involved with a care of the patient for the condition;
generate a patient snapshot based at least in part on the patient information collected;
monitor a status of the patient during the care by a subset of the one or more subscribed users;
update the patient snapshot to reflect the status of the patient; and
communicate at least one a portion of the patient snapshot, messages indicative of changes to the patient snapshot to the one or more subscribed users, or alerts indicating the status of the patient is adverse.
